(19) United States
(12) Patent Application Publication
(10) Pub. No.: US 2026/0303930 A1
(43) Pub. Date: Oct. 1, 2026

(54) SYSTEMS AND SERVER COMPUTING DEVICES THAT GENERATE MULTIPLE TRACKS FOR COMMUNICATION OF MULTIMEDIA CONTENT COMPONENTS

(71) Applicant: Lenovo Global Technology (United States) Inc., Morrisville, NC (US)

(72) Inventors: Fred Bower, III, Morrisville, NC (US); Silviu Eduard Lungu, Morrisville, NC (US); George-Andrei Stanescu, Morrisville, NC (US)

(21) Appl. No.: 19/093,445

(22) Filed: Mar. 28, 2025

(51) Int. Cl. H04N 21/81; H04N 21/439; H04N 21/84

(52) U.S. Cl. CPC H04N 21/816; H04N 21/4394; H04N 21/84

(57) ABSTRACT

Systems and server computing devices that generate multiple tracks for communication of multimedia content components are disclosed. According to an aspect, a server computing device includes a multimedia content manager. The multimedia content manager is configured to receive multimedia content including components of different types and/or characteristics. Further, the multimedia content manager is configured to determine two or more of the plurality of components of the multimedia content. The multimedia content manager is configured to generate multimedia communication tracks that correspond to components of the multimedia content. Further, the server computing device includes a communications module configured to communicate the plurality of components of the multimedia content to a destination computing device via the generated two or more multimedia communication tracks.

### TECHNICAL FIELD

The presently disclosed subject matter relates generally to communication and control of multimedia content. Particularly, the presently disclosed subject matter relates to systems and server computing devices that generate multiple tracks for communication of multimedia content components.

### BACKGROUND

Communications networks, particularly the Internet, are used for delivering multimedia content, such as videos and video games, to computing devices of end users. Multimedia content can be “streamed” to computing devices of end users in real-time or near real-time, thus allowing a user to experience the multimedia content without needing to download all of the data of the multimedia content before starting to experience it. Streaming technologies utilize a combination of data compression, buffering, and efficient network protocols to provide a user-friendly experience to the end user.

Multimedia content typically includes multiple different types of components that are integrated for leveraging multiple forms of expression. The specific components of multimedia content depend on the context. For example, a video, a website, or a video game may have different types of components. Example multimedia components include, but are not limited to, audio, images, text, and interactive media.

In some instances, an end user of streamed multimedia content may want to individually control one or more of the components of presented multimedia content. For example, the user may want to filter-out, enhance, or otherwise control an audio track of multimedia content. In another example of a streamed video game, the user may want to filter-out music in the video game. For at least these reasons, it is desired to provide systems and techniques to enable the control of components of streamed multimedia content.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of a system configured to generates multiple tracks for control and communication of multimedia content components in accordance with embodiments of the present disclosure;

FIGS. 2A and 2B are diagrams depicting a comparison of communication of multimedia content from an edge server to an end user computing device as a single stream to controllable communication of individual multimedia content tracks of components of the multimedia content in accordance with embodiments of the present disclosure;

FIG. 3 is a flow diagram of an example method for controlling and communication of multimedia content components in accordance with embodiments of the present disclosure;

FIG. 4 is a flow diagram of a method of halting communication of one or more generated multimedia communication tracks in accordance with an instruction from a destination computing device; and

FIG. 5 is a diagram of an example system configured to generates multiple tracks for control and communication of multimedia content components in accordance with embodiments of the present disclosure.

### SUMMARY

The presently disclosed subject matter relates to systems and server computing devices that generate multiple tracks for communication of multimedia content components. According to an aspect, a server computing device includes a multimedia content manager. The multimedia content manager is configured to receive multimedia content including components of different types and/or characteristics. Further, the multimedia content manager is configured to determine two or more of the plurality of components of the multimedia content. The multimedia content manager is configured to generate multimedia communication tracks that correspond to components of the multimedia content. Further, the server computing device includes a communications module configured to communicate the plurality of components of the multimedia content to a destination computing device via the generated two or more multimedia communication tracks.

In another aspect, a system includes a server computing device having a multimedia content manager. The multimedia content manager is configured to receive multimedia content including components of different types and/or characteristics. Further, the multimedia content manager is configured to determine two or more of the components of the multimedia content. The multimedia content manager is configured to generate multimedia communication tracks that correspond to components of the multimedia content. The server computing device includes a communications module configured to communicate the plurality of components of the multimedia content via a network. The system also includes a destination computing device configured to receive, via the network, the generated multimedia communication tracks for presentation via a user interface.

In another aspect, a method includes receiving multimedia content including multiple components of different types and/or characteristics. The method also includes determining two or more of the plurality of components of the multimedia content. Further, the method includes generating multimedia communication tracks that correspond to components of the multimedia content. The method also includes communicating components of the multimedia content to a destination computing device via the generated multimedia communication tracks.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

As referred to herein, the term “multimedia content” refers to digital content of multiple forms or types of media. Example multimedia includes, but is not limited to, images, video, audio, text, interactive media, and the like of different types of data. Multimedia content can include multiple data of the same type, such as multiple audio data or video data. Multimedia content can be used across digital platforms and delivered via suitable formats such as MP4, MP3, GIF, and HTML5. In many applications, multimedia content includes multiple components that carry these different types of data for streaming from one computing device to another computing device. In an example, an audio stream can carry multiple different sound components (e.g., music, voices, video game sounds, etc.). In another example, a video stream can carry multiple different video components (e.g., moving objects, animations, scenery, still images, etc.). In another example, a stream of multimedia content can carry one or more audio components and/or video components. Multimedia content can be streamed over a network (e.g., Internet, local area network, cellular network, etc.). These streams can be multiplexed together and synchronized for playback.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA,), a mobile computer with a smartphone client, or the like. A computing device as described herein can be configured to send or receive multimedia content streams. For example, a computing device can be a smartphone, tablet computer, smart TV or other streaming device, a desktop computer, a laptop computer, a gaming console, a media streaming box or set-top box, a smart speaker, Internet radio, and a virtual reality (VR) headset.

Computing device described herein that are enabled for multimedia content streaming can include hardware, software, and/or firmware components that can capture, encode, transmit, decode, and present the multimedia content. For example, hardware (e.g., CPU) of a computing device can implement software instructions for managing the streaming process. A graphic processing unit (GPU) can decode and render high-definition video streams. A computing device may include suitable memory for temporarily storing buffering streams. Further, a computing device may include flash storage for caching and storing downloaded multimedia content. In addition, a computing device may include audio-visual components for present multimedia content. For example, a user interface of a computing device can include a display for visual feedback of multimedia content. In another example, a user interface of a computing device can include audio hardware (e.g., digital-to-analog converter) for converting an audio component of multimedia content. In another example, a user interface of a computing device can include one or more speakers and a display for presentation of audio and video of a multimedia content stream. In another example, a user interface of a computing device can include a microphone and camera for capture of audio and visual imagery for streaming. In another example, a computing device can include hardware accelerators for efficient encoding and decoding of video streams.

Further, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

In embodiments, computing devices are disclosed herein that facilitate delivery of multimedia content to a destination computing device or end computing device. Such a computing device can facilitate streaming of multimedia content between a source computing device and a destination computing device. These computing devices can perform processing, storage, networking, and security of multimedia content. Examples of these computing devices include, but are not limited to, edge servers or other servers that operate within a network, such as the Internet. Edge servers are located at the “edge” of a network, near computing devices and users they serve. For example, an edge server may reside at a data center.

As referred to herein, the term “multimedia communication track” refers to a component of multimedia content in a form for communication. A multimedia communication track can be communicated to a destination computing device along with other multimedia tracks for presentation together at the destination computing device. A multimedia track can contain different types of media. Example multimedia communication tracks include, but are not limited to an audio track, a video track, a text track, an image track, and an effects track. An audio track can include, but is not limited to, music, voiceover, sound effects, and the like. A video track can include, but is not limited to, captured video, animations, overlays, and the like. A text track can include, but is not limited to, captions, subtitles, on-screen text, and the like. An image track can include, but is not limited to, still images, graphics, visual effects, and the like. An effects track can include, but is not limited to, filters, color grading, transitions, and the like.

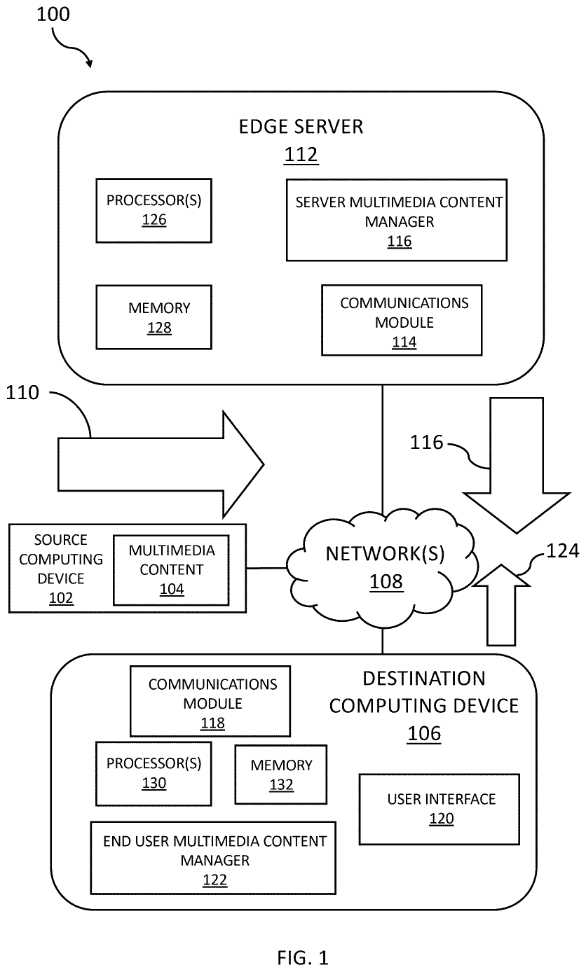

FIG. 1 illustrates a block diagram of a system 100 configured to generate multiple tracks for control and communication of multimedia content components in accordance with embodiments of the present disclosure. Referring to FIG. 1, a source computing device 102 can generate multimedia content 104 for streaming to one or more other computing devices. For example, the source computing device 102 may be a server, laptop computer, or desktop computer that generates the multimedia content 104 and communicates the multimedia content 104 to a destination computing device 106 via one or more networks 108 via a suitable streaming communications protocol. Arrow 110 depicts the communication of multimedia content 104 to the network(s) 108.

Server 112 can be operable within the network(s) and configured to manage and control streaming of multimedia between a source computing device and a destination computing device. For example, server 112 can be an edge server configured to manage and control streaming of video content and/or audio content from the source computing device 102 to the destination computing device 106. In other example, the server 112 can communicate text, interactive media, and the like of different types of data from the source computing device 102 to the destination computing device 106. The server 112 can include a communication module 114 configured to receive the multimedia content 104 via the network(s) 108.

The server 112 can include a multimedia content manager 116 configured to control and manage communication of the received multimedia content onto the destination computing device 106. Arrow 116 depicts the communication of multimedia content 104 from server 112 to destination computing device 106 via the network(s) 108. The destination computing device 106 can be operably connected to the network(s) 108 and include a communications module 118 for receipt of the multimedia content 104. The destination computing device 106 can include a user interface 120 configured to suitably present the received multimedia content 104 to the end user. For example, the user interface 120 can include a display (not shown) for presenting video and/or photos. In another example, the user interface 120 can include one or more speakers (not shown) for presenting audio content. Further, for example, the multimedia content manager 116 is configured to use the user interface 120 to present a control interface for controlling presentation of the generated two or more multimedia communication tracks.

The user interface 120 can also include input devices or equipment that enable the user to control presentation of the multimedia content, such as playback control, volume control, and the like. The destination computing device 106 can include a multimedia content manager 122 configured to control presentation of multimedia content via the user interface 120, and configured to receive commands entered by the user for presentation of multimedia content (e.g., playback and volume control).

In another example, the user can use the user interface to input a command for controlling presentation of the multimedia content. In this example, in response to the input command, the multimedia content manager 122 can receive the command and can control the communications module 118 to communicate the command to the server 112 via the network(s) 108. In response to receipt of the command, the server 112 can implement instructions according to the command. For example, the multimedia content manager 116 can control streaming (e.g., pausing streaming) of the multimedia content in response to receipt of a control command. Arrow 124 depicts the communication of a command from destination computing device 106 to the server 112 via the network(s) 108.

Multimedia content managers 116 and 122 may each be implemented of suitable hardware, software, firmware, or combinations thereof. For example, functionalities of the multimedia content manager 116 described herein can be implemented by one or more processors 126 that implement instructions stored in memory 128. Also, for example, functionalities of the multimedia content manager 122 described herein can be implemented by one or more processors 130 that implement instructions stored in memory 132.

In accordance with embodiments of the present disclosure, multimedia content manager 116 of server 112 can receive multimedia content that includes multiple components of different types and/or characteristics. For example, a type of component can include, but is not limited to, audio, images, text, interactive media, or the like. A characteristic of a component may include, for example, audio frequency, amplitude, timbre, duration, envelope, harmonics, directionality, rhythm, or the like. In an example of video, a component can include, but is not limited to, color, contrast, motion, audio, and the like.

The multimedia content manager 116 of server 112 can determine two or more of the components of the received multimedia content. For example, the multimedia content manager 116 can determine that multimedia content 104 includes video and one or more audio components for streaming to the destination computing device 106. Subsequent to determining the components of the received multimedia content, the multimedia content manager 116 can generate two or more multimedia communication tracks that correspond to the determined components of the multimedia content. For example, the multimedia content manager 116 can generate an audio track of the multimedia content 104, and can generate a video track of the multimedia content 104. Other example tracks include, but are not limited to, a text track, an image track, an effects track, or the like.

The multimedia content manager 116 can communicate the different multimedia communication tracks (e.g., audio track and video track) to the destination computing device 106 via the communications module 114. The communications module 114 can communicate the components of the multimedia content to the destination computing device 106 via the generated multimedia communication tracks. In this way, the multimedia content manager 116 can un-mix components of the multimedia content 104 and controllably communicate the different tracks to the destination computing device 106, rather than as a single stream of multimedia content.

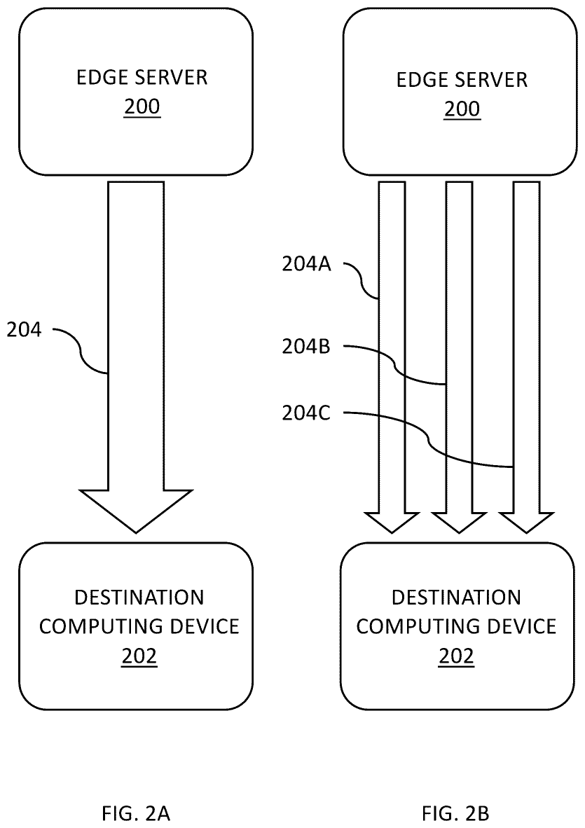

FIGS. 2A and 2B illustrate diagrams depicting a comparison of communication of multimedia content from an edge server 200 to an end user computing device 202 as a single stream to controllable communication of individual multimedia content tracks of components of the multimedia content in accordance with embodiments of the present disclosure. Referring to FIG. 2A, in this diagram the edge server 200 is streaming multimedia content to the destination computing device 202 as a single track (indicated by arrow 204). In this example, the track 204 includes two audio components and one video component. A user at the destination computing device 202 can control playback, pausing, and the like of streaming of the track 204 as described herein.

Now turning to FIG. 2B, a multimedia content manager of the end server 200 can determine the two audio components and the video component of the multimedia content. Further, the multimedia content manager of the end server 200 can generate multimedia communication tracks (indicated by arrows 204A, 204B, and 204C) that correspond to the two audio components and the video component of the multimedia content. Arrows 204A and 204B indicate a first audio track and a second audio track, respectively. For example, the first audio track may carry streamed background music of the multimedia content, and the second audio track may carry streamed gameplay music of the multimedia content in the instance of a videogame being streamed.

With continuing reference to FIG. 2B, now that the two components of audio and video component are streamed via separate tracks, the user can individually control presentation of the content carried by each track. In this example, the user can lower or turn off the volume of one of the audio tracks, such as the background music. In another example, the user can control communication of an instruction to the edge server 200 to halt communication (e.g., streaming) of one or more of the tracks in accordance with the instruction.

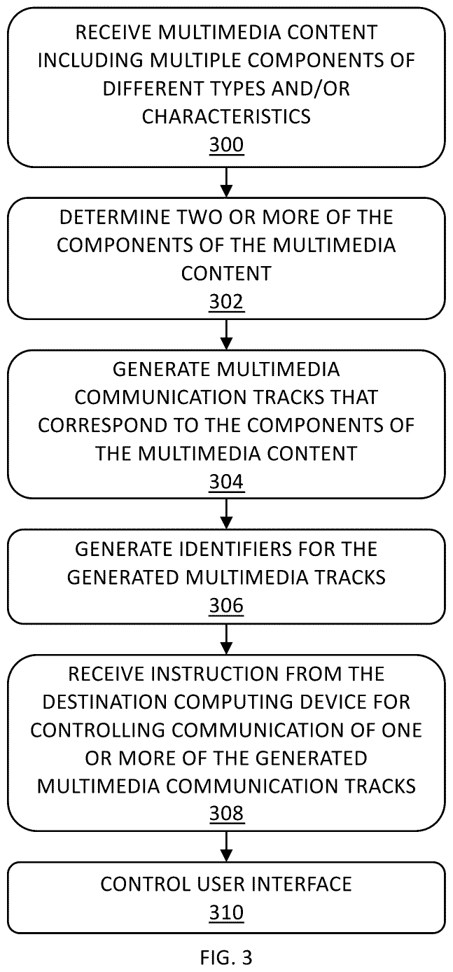

FIG. 3 illustrates a flow diagram of an example method for controlling and communication of multimedia content components in accordance with embodiments of the present disclosure. The method of FIG. 3 is described as by example as being implemented by the system 100 shown in FIG. 1, but it should be appreciated that the method may alternatively be implemented by any other suitable system.

Referring to FIG. 3, the method includes receiving 300 multimedia content including multiple components of different types and/or characteristics. For example referring to FIG. 1, the edge server 112 can receive streamed multimedia content from the source computing device 102. In an example, the user at the source computing device 102 can be engaged in an online game with the user at destination computing device 106. In this example, the multimedia content streamed to the destination computing device 106 includes the video gameplay content of video, audio detected by a microphone of the user of source computing device 102, gameplay audio, and background music. This gameplay multimedia content can be received at the edge server 112 via the communications module 114.

The method of FIG. 3 includes determining 302 two or more of the components of the multimedia content. Continuing the aforementioned example, the multimedia content manager 116 of the edge server 112 can determine the different components of video, audio detected by a microphone of the user of source computing device 102, gameplay audio, and background music that are part of the multimedia content stream. In an example, different components may be designated by tagging the data at the point of origin, computing device 102, prior to transmission to the edge server 112. In another example, the multimedia content manager 116 of the edge server 112 may perform analysis on the received multimedia stream to further identify and create separate multimedia tracks. Analysis may include signal processing techniques as well as the application of neural networks (e.g., artificial intelligence) to identify components that have not previously been segregated or that may have been segregated at one time but integrated prior to transmission to the edge server 112.

The method of FIG. 3 includes generating 304 multimedia communication tracks that correspond to the components of the multimedia content. Continuing the aforementioned example, the multimedia content manager 116 of the edge server 112 can generate multimedia communication tracks that correspond to the components of video, audio detected by a microphone of the user of source computing device 102, gameplay audio, and background music that are part of the multimedia content stream. For example, the media content manager 116 of the edge server 112 can generate a separate track for each of the components of the multimedia content stream.

The method of FIG. 3 includes generating 306 identifiers for the generated multimedia communication tracks. Continuing the aforementioned example, the multimedia content manager 116 of the edge server 112 can generate an identifier for each of the multimedia communication tracks. In this way, the edge server 112 and other computing devices (e.g., the destination computing device 106) can reference a specific track. The multimedia content manager 116 of the edge server 112 can control the communications module 114 to communicate the generated identifier for the multimedia communication tracks to the destination computing device 106. Also, for example, the identifier can indicate a characteristic of the streamed component on the track. For example, tracks can be generated that correspond to particular frequencies. For example, the identifiers can indicate the type of component streamed on the track (e.g., indicate that it is audio, video, background music). Example audio track components can be a type of instrument (e.g., piano, violin, guitar, etc.), a talking voice, or a singing voice.

The method of FIG. 3 includes receiving 308 instruction from the destination computing device for controlling communication of one or more of the generated multimedia communication tracks. Continuing the aforementioned example, the user of the destination computing device 106 can be presented with identifiers or some indicia of the streamed multimedia communication tracks. The identifiers or other indicia of the different streamed multimedia communication tracks can be suitably displayed on a display of the user interface 120. The user of the destination computing device 106 can user the user interface to select one or more of the tracks for controlling presentation of the selected track(s). For example, the user may select the identifier of a track to stop presentation of the track. The multimedia content manager 122 of the destination computing device 106 may control the user interface 120 in accordance with the instruction (e.g., stop audio or display of video). In this way, the user can individually control one or more of the components of presented multimedia content.

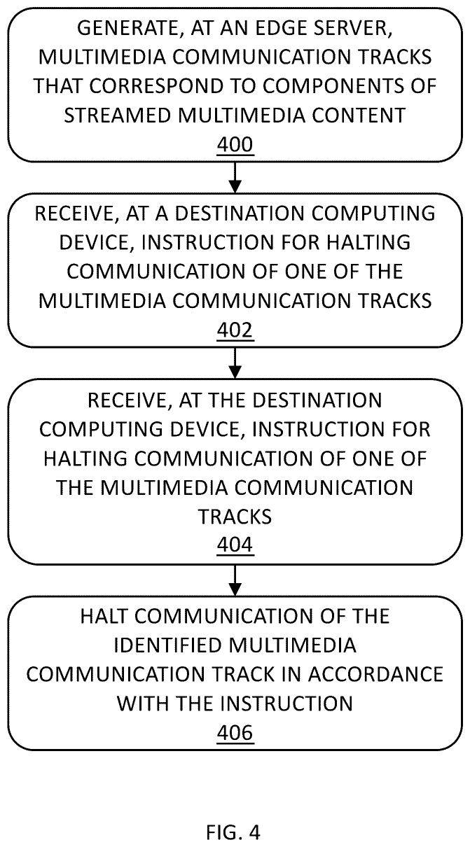

In embodiments of the present disclosure, a user at a destination computing device can control an end server (or other computing device streaming multimedia content) to halt communication of one of the generated multimedia communication tracks. For example, FIG. 4 illustrates a flow diagram of a method of halting communication of one or more generated multimedia communication tracks in accordance with an instruction from a destination computing device. The method of FIG. 4 is described as by example as being implemented by the system 100 shown in FIG. 1, but it should be appreciated that the method may alternatively be implemented by any other suitable system.

Referring to FIG. 4, the method includes generating 400, at an edge server, multimedia communication tracks that correspond to components of streamed multimedia content. For example referring to FIG. 1, the multimedia content manager 116 of the edge server 112 can generate multimedia communication tracks that correspond to components of streamed multimedia content as described herein. Further, the multimedia content manager 116 can generate an identifier for each of the multimedia communication tracks and can communicate the identifiers to the destination computing device 106 that is receiving the streamed multimedia content via the generated multimedia communication tracks.

The method of FIG. 4 includes receiving 402, at a destination computing device, instruction for halting communication of one of the multimedia communication tracks. Continuing the aforementioned example, the user of the destination computing device 106 can enter an instruction that identifies a multimedia communication track to halt. The user can enter the instruction by input into the user interface 120. The multimedia content manager 122 of the destination computing device 106 can communicate the instruction to the edge server 112 via the communication module 118.

The method of FIG. 4 includes receiving 404, at the edge server, instruction from the destination computing device for halting communication of the identified multimedia communication track. Continuing the aforementioned example, the edge server 112 can receive the instruction.

The method of FIG. 4 includes halting 406 communication of the identified multimedia communication track in accordance with the instruction. Continuing the aforementioned example, the multimedia content manager 116 of the edge server 112 can halt communication of the identified multimedia communication track in accordance with the instruction. The multimedia content manager 116 of the edge server 112 can permit communication of the other multimedia communication tracks of the streamed multimedia content while the identified multimedia communication track is halted. In this way, the user can selectively identify a multimedia communication track to halt while other multimedia communication tracks of the same streamed multimedia content continue to be communicated. It is noted that the user can also select to unhalt communication of the previously identify multimedia communication track to thereby enable it to resume communication.

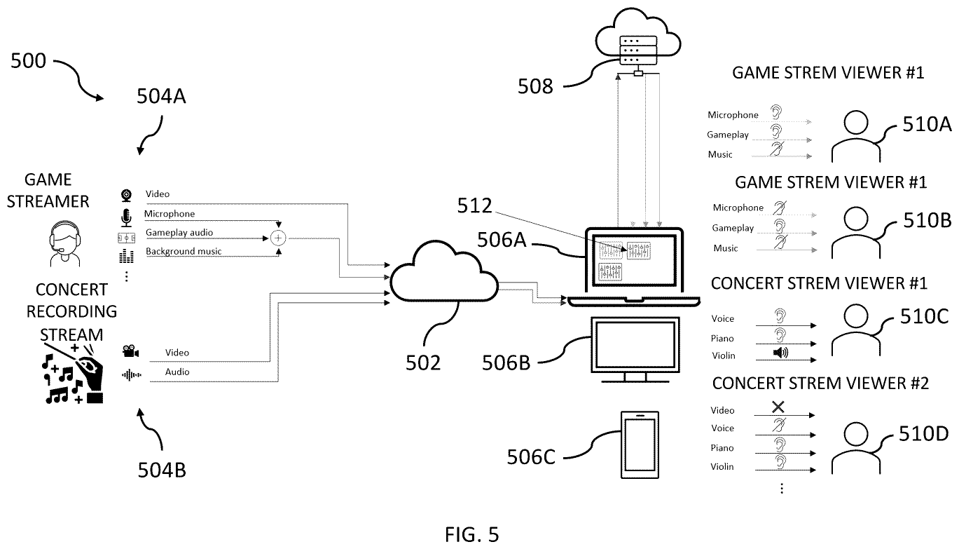

FIG. 5 illustrates a diagram of an example system 500 configured to generate multiple tracks for control and communication of multimedia content components in accordance with embodiments of the present disclosure. Referring to FIG. 5, the system 500 includes a communications network 502 configured to communicatively connect source computing devices, generally designated 504A and 504B, with destination computing devices 506A, 506B, and 506C. In this example, source computing devices 504A and 504B are generating and streaming multimedia content to an edge server 508 (or other suitable network equipment) for routing to destination computing devices 506A, 506B, and/or 506C. Source computing device 504A is streaming gameplay multimedia content including the components of video, microphone-recorded audio, gameplay audio, and background music. Source computing device 504B is streaming multimedia content of a live concert including the components of video and audio.

In accordance with embodiments, the edge server 508 includes a multimedia content manager (not shown) configured to receive the multimedia content from source computing devices 504A and 504B, and to determine the components of the multimedia content being streamed by source computing devices 504A and 504B. Particularly, the multimedia content manager of the edge server 508 can determine that the components of the multimedia content streamed by source computing device 504A includes the components of video, microphone-recorded audio, gameplay audio, and background music. Further, the multimedia content manager of the edge server 508 can determine that the components of the multimedia content streamed by source computing device 504B includes the components of video and audio. The multimedia content manager of the edge server 508 is also configured to determine components of voice, piano, and violin based on frequencies and/or other characteristics of the audio, and generate specific tracks for these components.

The multimedia content manager of the edge server 508 can generate multimedia communication tracks that correspond to the components of the multimedia content streamed by source computing devices 504A and 504B. Further, the multimedia content manager of the edge server 508 can communicate the components of the multimedia content to destination computing devices 506A, 506B, and 506C via multimedia communication tracks. In this example, computing devices of end users 510A and 510B can receive streams of the multimedia communication tracks of the microphone audio, gameplay audio, and music of the gameplay multimedia content provided by source computing device 504A. Further for example, computing devices of end users 510C and 510D can receive streams of the multimedia communication tracks of the voice, piano, violin, and video of the live concert multimedia content provided by source computing device 504A.

In accordance with embodiments of the present disclosure, users 510A-510D can enter into their respective computing device instructions for controlling communication of the multimedia communication tracks streamed to their respective computing devices. A user interface of these destination computing devices can present a control interface for receiving the instructions and identifying the tracks. Users 510A-510D can interact with the control interfaces to identify tracks to control along with an action, such as halting the track, playback of the track, muting, and the like.

In the example of entering an action to halt a track, the respective destination computing device can communicate an instruction to the edge server 508 to halt streaming of the identified track. For example, the user 510D has selected to halt the video track. In response to this selection and communication of an instruction to halt the video track, the edge server 508 can halt streaming of the video track while continuing to stream the voice track, the piano track, and the violin track. Further, in this example, the user 510D has selected to mute the voice track such that only the piano track and violin track are played. As a result, the user 510D has the ability to isolate and only play the instrumental components of the live stream. Similarly for example, user 510A has selected to mute the music track, and user 510B has selected to mute the microphone audio track and the music track.

In an example, a display of a user interface can display a control interface for adjusting volume of tracks, muting tracks, or otherwise adjusting presentation of a track. For example, reference number 512 generally indicates display of multiple mixer interfaces displayed on a display screen of destination computing device 506A for muting, unmuting, adjusting volume, and adding audio effects.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPhone® smart phone, an iPad® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini-or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A server computing device comprising:
a multimedia content manager configured to:
receive multimedia content including a plurality of components of different types and/or characteristics;
determine two or more of the plurality of components of the multimedia content; and
generate two or more multimedia communication tracks that correspond to the plurality of components of the multimedia content; and
a communications module configured to communicate the plurality of components of the multimedia content to a destination computing device via the generated two or more multimedia communication tracks.

2. The server computing device of claim 1, wherein a type of a component includes one of audio, images, text, and interactive media.

3. The server computing device of claim 1, wherein a characteristic of a component includes one of audio frequency, amplitude, timbre, duration, envelope, harmonics, directionality, and rhythm.

4. The server computing device of claim 1, wherein a characteristic of a component includes a component of a video comprising one of color, contrast, motion, and audio.

5. The server computing device of claim 1, wherein a multimedia communication track includes one of an audio track, a video track, a text track, an image track, and an effects track.

6. The server computing device of claim 1, wherein the communications module is configured to receive the multimedia content.

7. The server computing device of claim 1, wherein the multimedia content manager is configured to generate identifiers for the generated two or more multimedia communication tracks, and
wherein the communications manager is configured to communicate the generated identifiers to the destination computing device.

8. The server computing device of claim 1, wherein the multimedia content manager is configured to:
receive instruction from the destination computing device for controlling the communication of at least one of the generated two or more multimedia communication tracks; and
control communication of the at least one of the generated two or more multimedia communication tracks in accordance with the instruction.

9. The server computing device of claim 1, wherein the multimedia content manager is configured to:
receive instruction from the destination computing device for halting communication of at least one of the generated two or more multimedia communication tracks; and
halt communication of the at least one of the generated two or more multimedia communication tracks in accordance with the instruction.

10. A system comprising:
a server computing device comprising:
a multimedia content manager configured to:
receive multimedia content including a plurality of components of different types and/or characteristics;
determine two or more of the plurality of components of the multimedia content; and
generate two or more multimedia communication tracks that correspond to the plurality of components of the multimedia content; and
a communications module configured to communicate the plurality of components of the multimedia content via a network; and
a destination computing device configured to receive, via the network, the generated two or more multimedia communication tracks for presentation via a user interface.

11. The system of claim 10, wherein a type of a component includes one of audio, images, text, and interactive media.

12. The system of claim 10, wherein a multimedia communication track includes one of an audio track, a video track, a text track, an image track, and an effects track.

13. The system of claim 10, wherein the multimedia content manager is configured to generate identifiers for the generated two or more multimedia communication tracks, and
wherein the communications manager is configured to communicate the generated identifiers to the destination computing device.

14. The system of claim 10, wherein the multimedia content manager is configured to:
receive instruction from the destination computing device for controlling the communication of at least one of the generated two or more multimedia communication tracks; and
control communication of the at least one of the generated two or more multimedia communication tracks in accordance with the instruction.

15. The server of claim 10, wherein the multimedia content manager is configured to:
receive instruction from the destination computing device for halting communication the communication of at least one of the generated two or more multimedia communication tracks; and
halt communication of the at least one of the generated two or more multimedia communication tracks in accordance with the instruction.

16. The system of claim 10, wherein the destination computing device is configured to communicate the multimedia content to the server computing device for generation of the two or more multimedia communication tracks.

17. The system of claim 10, wherein the server computing device is configured to receive the multimedia content from a source computing device that is different than the destination computing device.

18. The system of claim 10, wherein the user interface is configured to present a control interface for controlling presentation of the generated two or more multimedia communication tracks.

19. The system of claim 13, wherein the destination computing device is configured to:
receive, via the user interface, instruction to halt presentation of one of the generated two or more multimedia communication tracks; and
halt the one of the generated two or more multimedia communication tracks based on the instruction.

20. A method comprising:
receiving multimedia content including a plurality of components of different types and/or characteristics;
determining two or more of the plurality of components of the multimedia content;
generating two or more multimedia communication tracks that correspond to the plurality of components of the multimedia content; and
communicating the plurality of components of the multimedia content to a destination computing device via the generated two or more multimedia communication tracks.
